(19) United States
(12) Patent Application Publication
(10) Pub. No.: US 2005/0276568 A1
(43) Pub. Date: Dec. 15, 2005

(54) Portable media recording device

(76) Inventor: Augustino Korkis, Chicago, IL (US)

Correspondence Address: Robert L. Knechtel;Law Offices of Mark E. Wiemelt, P.C., Suite 3300, 10 South LaSalle Street, Chicago, IL, 60603, US

(21) Appl. No.: 10/856,099

(22) Filed: Jun. 1, 2004

(51) Int. Cl. H04N 5/76; H04N 5/781

(52) U.S. Cl. 386/46; 386/125

(57) ABSTRACT

A universal readable/writable memory storage mechanism that interfaces with a variety of consumer electronic devices to enable storage, playback, and transfer of data between a range of devices is provided.

### FIELD OF THE INVENTION

The present invention relates generally to the field of portable media recording devices and readable/writable memory storage devices. More particularly, the present invention is directed to devices that manage and store the input of audio, video and multimedia data from a wide variety of consumer electronic and other data sources. The present invention facilitates the transfer of that data between various consumer electronic and multimedia devices, even where the separate input and output devices operate on altogether different platforms and are generally unable to communicate without a computer or a dedicated intermediary device.

### BACKGROUND OF THE INVENTION AND PRIOR ART

The electronic devices owned and operated by today's consumers are more numerous and more varied in function than ever before. Portable CD and cassette-players, MP3 players, cell phones with video and text-messaging capability, palmtop computers, PDA's and handheld organizers, digital cameras and camcorders represent only some of the portable multimedia devices in widespread use today.

A problem associated with use of this plethora of devices is that, too often, they are only able to act as independent, standalone devices. Storage of audio, video and other data is normally limited to the original medium itself. If transfer of files between different media and different formats is possible at all, it is only with an inconvenient intermediary device dedicated to bridging two, and only two, different devices, or is accomplished through the use of a computer, which is a bulky and inopportune solution and can require a degree of computer skills not possessed by the average user of consumer electronics.

There have been several devices proposed that address the transfer of data but there is no single device available that enables a user to variously record and transfer data from and between a variety of audio and video data sources. For example, U.S. Pat. No. 4,713,801 to Hale discloses an audio device for automotive use in which radio signals are recorded onto magnetic tapes. The patent does not disclose the ability to record other media, such as compact discs, or the ability to produce digital recordings of any kind. The patent also has no ability to cause the playback from multiple data sources.

Another example is seen in U.S. Pat. No. 5,633,837 to Gantt which discloses a device for use in an automobile to record radio programs onto a solid state memory. While a technological advance over the Gantt patent, it suffers from many of the same shortcomings. This patent does not disclose the ability to record, for example, compact discs, although it does teach digital recording capability. Also, this device only teaches the transfer of audio data in one direction; that is, from a car radio to a recording device. Finally, the device taught by the '837 patent is relatively inflexible in that it does not address recording from devices other than a car radio.

A further example is found in U.S. Pat. No. 6,212,555 to Brooks, Jr. et al. which discloses a digital recording device for recording, storing and playing back audio material. The device teaches recording and playback flexibility and teaches receiver unit use in an automobile. However, the '555 patent does not address the storage and playback of video or other multimedia files, nor does it interface with other digital media.

Additionally, various consumer electronic devices allow, to a small degree, the transfer and interplay of various forms of data. However, none of these devices provide a universal interface or generic data transfer mechanism.

For example, the Sony Clie Entertainment Handheld Organizer is a multifunction device that allows its user to take digital photos, play digital videos, record voice memos and play back digital audio files. However, the Sony device lacks the feature of universal connectivity. The Sony product cannot, for example, transfer cell phone audio content for playback on a car stereo.

The same is true for other devices on the market. MP3 players, digital voice recorders, camcorders and cell phones all have the ability to acquire and store data, but are unable to interface and share content with one another without a computer or some other dedicated intermediary device.

There is need, therefore, for a device that enables a user to universally record data from various media, be it radio signal, magnetic tape, digital audio and video recorder, or other means and transfer it to other data sources without the need for multiple interconnectivity devices or a computer. Such uses and benefits include, but are not limited to, playback of cell phone voicemail by a car stereo, transfer of an image from a digital camera to a PDA, transfer of music from a CD walkman to a car stereo, or conveyance of audio from a car stereo to a laptop computer. In short, the invention provides a universal interface between devices that operate on altogether different platforms and enables a corresponding synergy attendant with the integration of a wide array of electronic devices. The present invention is provided for in a small, portable, and easy-to-use housing. It is easy to envision the benefits of the invention. For example, a person driving home from work could play back his cell phone voicemail messages on his car stereo and record voice comments on his PDA. A user could record music or other programming from a radio program and play it back at a later time on a PDA, computer or stereo. Ideally, the device will include buffering means that enables the user, through a delay mechanism, to record only those songs or programs that are desired.

The instant invention provides a break through in the storage, playback, and transfer of digital audio and video data for playback without the presence of the original medium.

### OBJECTS AND ADVANTAGES OF THE INVENTION

It is an object of this invention to provide a storage means for audio, visual and other multimedia data without the presence of the original medium.

It is a further object of this invention to provide a mechanism for the transfer of visual, audio and multimedia data from the original format or device to another, even where the new format or device does not share a platform with the original.

It is yet a further object of this invention to provide a means of data storage and transfer that is easy to use, light-weight and portable, and is convenient to use.

It is an advantage of this invention that it provides a universal interface between electronic devices that operate on altogether different platforms and enables a corresponding synergy associated with the linkage of a wide array of electronic devices.

### BRIEF DESCRIPTION OF THE INVENTION

According to the invention, a readable/writable memory storage mechanism that interfaces with consumer electronic devices to enable storage, playback, and transfer of data between devices is provided. The inventive device allows a heretofore unparalleled degree of interaction between devices and the concomitant benefits attained thereby.

The inventive device provides at least the following capabilities:
a) Encoding and decoding Layer 3 MPEG: The device has the ability to convert digital audio signals to the highest quality MPEG format.
b) Reading and writing to at least two separate memory devices; for example, Smart Card and Flash memory.
c) Upload and download of MPEG files from memory devices: The device provides the end-user a portable solution for MPEG file transfer.
d) Upload and download of MPEG files to PC using USB or parallel port
e) Stereo and mono conversion of Audio input (FM/AM radio, CD, Tape) to MPEG, S/PDIF digital audio.
f) S/PDIF input to MPEG and headphone output.
g) Audio output to headphones jack that enable the end-user to plug headphones directly into the device to listen to their stored files.
h) Microphone input and conversion to MPEG files: The device enables the end-user to have voice recording capability.
i) User enabled record function: The device permits easy record initiation.
j) Delayed data capture and recover buffer: The device contains an at least ten second recovering buffer to allow the end-user to recover missed snippets of data.
k) Voice to text function for labeling stored data files: The end-user is able to label songs through the device's voice recognition abilities.
l) Graphics LCD display that serves as a navigation tool, showing menu options through a backlit display.
m) File I/O system controlled through three button interface: User-friendly interface, controlled by 3 buttons to navigate through menus.
n) Random playback or programmable playback lists: The device enables the end-user the ability to select random song playback or to program a list of selected songs to play from the created song menu.
o) System power from host or stand-alone single cell Nickel Metal Hydride providing long use times between charges. The invention contemplates an infinite power source when using an auto battery or USB port. If an auto battery or USB port is unavailable, a single cell Nickel Metal Hydride powers the system.
p) System re-charge from host (Auto or USB port). The system also includes a low battery indicator to notify the user that the battery levels are low and that it needs to be recharged.

There are, of course, additional features of the invention that will be described hereinafter and that will form the subject matter of the invention. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the present invention in any way.

These, together with other objects of the present invention, along with the various features of novelty which characterize the present invention, are pointed out with particularity in the claims annexed to and forming a part of this disclosure. For a better understanding of the present invention, its operating advantages and the specific objects attained by its uses, reference should be had to the accompanying drawings and descriptive matter in which there is illustrated a preferred embodiment of the present invention.

### BRIEF DESCRIPTION OF THE DRAWINGS

FIG. 1 depicts a schematic illustrating a general overview of the inventive device.

FIG. 2 depicts a block diagram illustrating input media connected to the inventive device.

FIG. 3 depicts a block diagram illustrating playback media connected to the inventive device.

### DETAILED DESCRIPTION OF THE PREFERRED EMBODIMENT

The invention will now be described in detail with regard for the best mode and the preferred embodiment. In general, the present invention is a portable media recording device 20 comprising input terminals 22, readable/writable memory 24, and playback terminals 26. More particularly, the present invention is designed to manage and store the input of audio, video and multimedia data from a wide variety of consumer electronic and other data sources. The present invention facilitates the transfer of that data between various consumer electronic and multimedia devices, even where the separate input and output devices operate on altogether different platforms and are generally unable to communicate without a computer or a dedicated intermediary device.

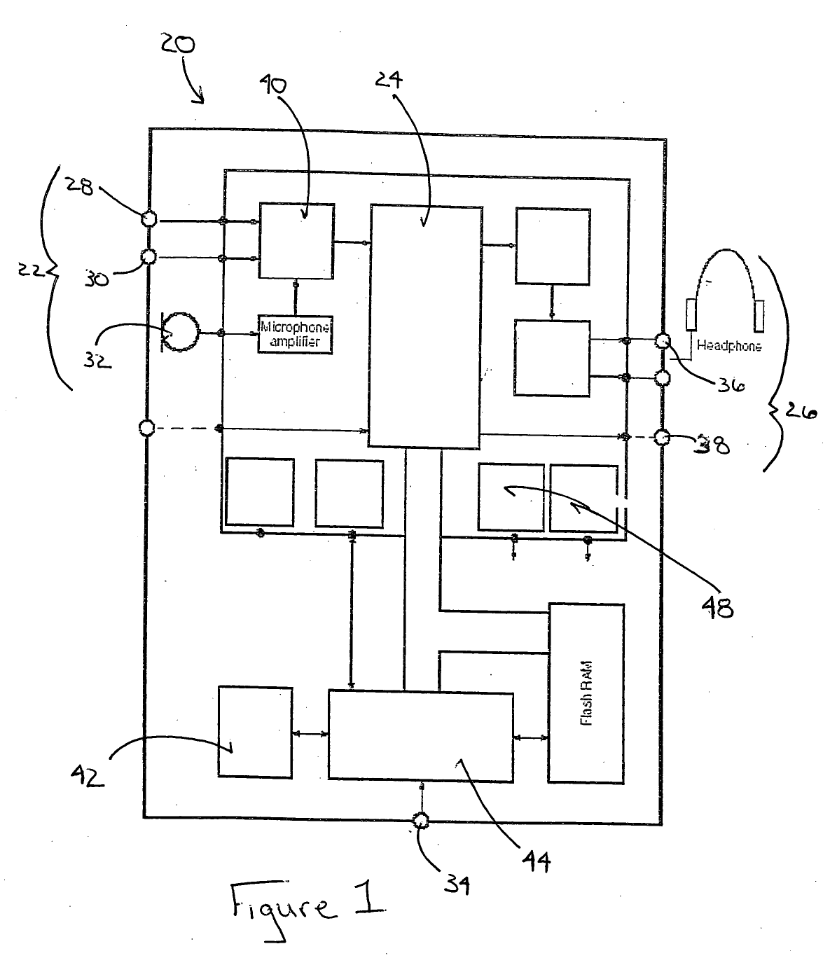

Turning to FIG. 1, a general schematic of device 20 is seen. Input terminals 22 further comprises sufficient input terminals as is necessary for the function of the device. Currently contemplated are USB terminal 28, parallel port 30, microphone 32, and computer connector 34. While these input terminals are currently contemplated, those skilled in the arts will quickly realize that as technology advances, additional types of input terminals may be devised. The use of such terminals could easily be employed in the present device and be within the scope, spirit, and purpose of the inventive device.

Also as will be appreciated by those skilled in the arts will appreciate, these input terminal types are competent to handle all forms of media data transmission whether it be audio or visual, analog or digital.

Input terminals 22 relay inputted media data to readable/writable memory 24. At this point, media data is encoded into MPEG files from the inputted format. The media is now stored in the readable/writable memory until such time as playback is desired. Preferably, the device will contain both Smart Card and Flash memory in the form of two separate memory devices. However, this is not critical to the invention; one memory device may be sufficient if it meets the needs of use. Further, the memory will be capable of stereo and mono conversion of Audio input (FM/AM radio, CD, Tape) to MPEG, S/PDIF digital audio.

Moreover, memory 24 will have a ten second data capture and recover buffer. This will enable a User to recover missed snippets of songs.

The Inventor contemplates that memory 24 will hold several hours of data. As a feature of its encoding properties, memory 24 will also be capable of storing multiple types of data. For example, a user may input audio data in the form of a voice message through the microphone 32 and also download music from the Internet. Memory 24 will encode all data so it can be stored and retrieved as needed.

When playback is desired, a User will select a playback mode and use the appropriate output terminal 26 selected from a headphone jack 36 or a device jack 38. These jacks will enable a User to establish an output connection with virtually every playback device. Non-limiting examples include headphones, speakers, a computer, or radio having input terminals.

Microphone 32 will also be connected to voice to text means 40 function for labeling stored data files: The end-user will be able to label songs through the device's voice recognition abilities thereby providing a means to visibly identify a particular inputted data via graphic display 42. It is contemplated that graphic display 42 will be of an LCD type. Through interface 44 a User will be able to program a random playback or programmable playback lists: The device will allow the end-user the ability to select random song playback or to program a list of selected songs to play from the created song menu. User-friendly interface 44 also enables a User to navigate through menus.

System power comes from stand-alone single cell Nickel Metal Hydride 48 or the host can supply infinite power source when using an auto battery or USB port.

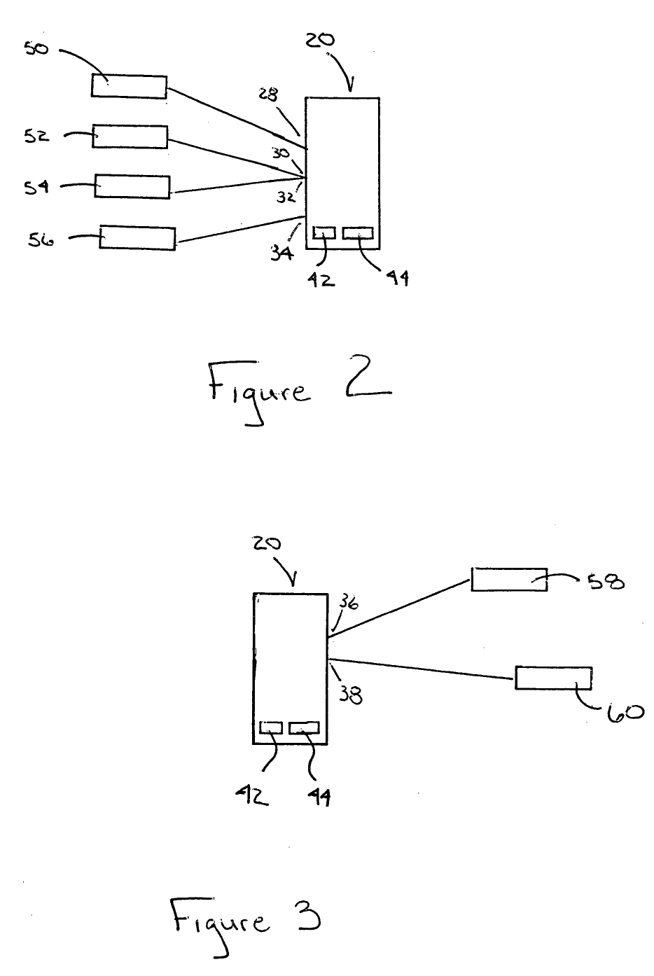

Turning to FIG. 2 a block diagram illustrating input media connected to the inventive device is seen. As shown, example input media is depicted as am MP3 player 50 connected to device 20 via USP port 28, CD player 52 is connected via parallel port 52, voice data is inputted through microphone 32, computer 56 is connected via computer terminal 34. As will be realized by those skilled in the arts, these are only examples. For instance, computer 56 could be connected also via USB port 28 or parallel port 30.

Data is then encoded and stored internally by memory 24 (not shown). A User can also add labeling to inputted media via microphone 32 by manipulating interface 44. A visual display will appear on display 42.

Turning to FIG. 3, a block diagram illustrating playback media connected to the inventive device is shown. When media playback is desired, device 20 can be connected to a playback device. As shown in FIG. 3, headphone terminal 36 can be connected to headphones or speaker. Device jack 30 can be connected to radios having input lines, computers, or other devices. Upon entering playback mode, a User can select a random playback or set a playback list by manipulating interface 44 and viewing the results on display 42.

This invention is described with reference to the present embodiment. The scope of protection for the invention is that defined by the claims appended hereto. Reasonable modifications, changes and variations may be made by those of ordinary skill in the art which will fall within the scope of the appended claims.

1) a media recording, storage, and transfer device for use with devices having media playback capabilities comprising:
at least one port for connecting to a media input device;
an encoder/decoding for encoding data and decoding data received from the media input device into MPEG files;
at least one reading and writing memory card for storing the encoded data;
at least one port for connecting to a media playback device; and,
a power supply for powering the device.

2) The media recording, storage, and transfer device of claim 1 further including a microphone input for receiving voice recorded data.

3) The media recording, storage, and transfer device of claim 1 wherein the at least one port for connecting to a media input device further includes any of a USB port, parallel port, a microphone, or a computer terminal.

4) The media recording, storage, and transfer device of claim 1 wherein the memory card is selected from the group of Smart cards and flash cards.

5) The media recording, storage, and transfer device of claim 1 further including a stereo and mono converter for converting audio input to MPEG, S/PDIF digital audio.

6) The media recording, storage, and transfer device of claim 1 further including audio output to headphones.

7) The media recording, storage, and transfer device of claim 1 further including a user enabled record function.

8) The media recording, storage, and transfer device of claim 1 further including a data capture and recover buffer.

9) The media recording, storage, and transfer device of claim 1 further including voice to text function for labeling stored data files.

10) The media recording, storage, and transfer device of claim 1 further including a graphics LCD display for use as a system navigation tool.

11) The media recording, storage, and transfer device of claim 1 further including the capability to perform both random playback or programmable playback lists.

12) The media recording, storage, and transfer device of claim 1 further including a recahargable power supply.
